(19) United States
(12) Patent Application Publication
(10) Pub. No.: US 2012/0152774 A1
(43) Pub. Date: Jun. 21, 2012

(54) HOLDERS FOR PORTABLE MEMORY CARDS AND METHODS FOR MANUFACTURING SAME

(76) Inventors: Ariel Navon, Hod-Hasharon (IL); Itzhak Pomerantz, Kefa Sava (IL); Rahav Yairi, Oranit (IL)

(21) Appl. No.: 12/866,451

(22) PCT Filed: Sep. 16, 2009
(86) PCT No.: PCT/IB09/06853

§ 371 Date: Aug. 5, 2010

Related U.S. Application Data
(60) Provisional application No. 61/240,999, filed on Sep. 9, 2009.

(51) Int. Cl. B65D 85/86; B23P 17/00

(52) U.S. Cl. 206/307; 29/592

(57) ABSTRACT

Holders for portable memory cards and methods for manufacturing such holders are provided. A holder for a portable memory card described herein is configured to attach to a host device such that a portable memory card can travel with a host even when the portable memory card is not being used with the host. A holder for a portable memory card described herein may have a low profile design compatible with host electronic devices of increasingly small form factor, such as mobile phones and portable media players. A holder for a portable memory card may also include a lock for locking a portable memory card in a compartment formed by the memory card holder to prevent accidental removal of the portable memory card from the compartment.

### PRIORITY CLAIM

This application claims the benefit of U.S. Provisional Patent Application Ser. No. 61/240,999, filed Sep. 9, 2009; the disclosure of which is incorporated herein by reference in its entirety.

### TECHNICAL FIELD

The subject matter described herein relates to holders for portable memory cards. More particularly, the subject matter described herein relates to low profile holders for portable memory cards that attach to host devices and methods for manufacturing such holders.

### BACKGROUND

Portable memory cards are increasingly being used to provide removable storage for host devices, including media players, mobile telephones, personal digital assistants (PDAs), smart phones, portable radios, global positioning system (GPS) devices, digital cameras, and combinations thereof. Most of these host devices typically hold a single removable, portable memory card. However, in some instances, a user may desire to carry additional portable memory cards. For example, portable memory cards that are preloaded with music are increasingly being used in portable media players. A user may desire to play the media on one portable memory card while carrying one or more additional portable memory cards with different media to which the user desires listen at a later time. One problem with this scenario is that portable memory cards have a very small form factor and are easily lost or damaged.

Enclosures exist for storing portable memory cards. For example, clam shell type enclosures for holding portable memory cards for GPS devices are currently available. However, such enclosures are cumbersome to carry and sometimes difficult to open. In addition, because such enclosures are separate from the host, they may not travel with the host and are subject to some of the same problems, e.g., loss or unavailability, as portable memory cards that are loosely carried separately from the host.

Accordingly, in light of these difficulties, there exists a need for improved holders for portable memory cards and methods for manufacturing such holders.

### SUMMARY

Holders for portable memory cards and methods for manufacturing such holders are provided. A holder for a portable memory card described herein is configured to attach to a host device such that a portable memory card can travel with a host even when the portable memory card is not being used with the host. A holder for a portable memory card described herein may have a low profile design compatible with host electronic devices of increasingly small form factor, such as mobile phones and portable media players. A holder for a portable memory card may also include a lock for locking a portable memory card in a compartment formed by the memory card holder to prevent accidental removal of the portable memory card from the compartment.

### BRIEF DESCRIPTION OF THE DRAWINGS

Preferred embodiments of the subject matter described herein will now be explained with reference to the accompanying drawings of which:

FIG. 1 is a front perspective view of a holder for a portable memory card according to an embodiment of the subject matter described herein;

FIG. 2 is a rear perspective view of the memory card holder of FIG. 1;

FIG. 3 is a bottom perspective view of the memory card holder of FIG. 1;

FIG. 4 is a front perspective view of the memory card holder of FIG. 1 and a portable memory card inserted therein;

FIG. 5A is a top perspective view of a memory card holder illustrating locking of a portable memory card in the compartment according to an embodiment of the subject matter described herein;

FIG. 5B is a front perspective view of a memory card holder according to an alternate embodiment of the subject matter described herein;

FIG. 5C is a front perspective view of a memory card holder according to yet another alternate embodiment of the subject matter described herein;

FIG. 6A is a top view illustrating unitary structure used to form the memory card holder of FIG. 1 and lines for bending the sidewall members and the end wall member to form the memory card holder of FIG. 1;

FIG. 6B is a flow chart illustrating exemplary steps for manufacturing the memory card holder of FIG. 1;

FIG. 7 is a front perspective view illustrating a holder for a portable memory card according to another embodiment of the subject matter described herein;

FIG. 8 is a bottom view of the memory card holder of FIG. 7;

FIG. 9 is a bottom perspective view of the memory card holder of FIG. 7 with a portable memory card inserted therein;

FIG. 10 is a front perspective view of a memory card holder according to another embodiment of the subject matter described herein;

FIG. 11 is a top perspective view of the memory card holder of FIG. 10;

FIG. 12 is a front perspective view of the memory card holder of FIG. 10 with a portable memory card inserted therein;

FIG. 13A is a perspective view of memory card holders attached to a host according to an embodiment of the subject matter described herein;

FIG. 13B is a front view of a memory card holder and a paper clip to illustrate an exemplary size of a memory card holder according to an embodiment of the subject matter described herein;

FIG. 13C is a perspective view of a memory card holder with a portable memory card inserted therein according to another embodiment of the subject matter described herein;

FIG. 14 is a top view illustrating memory card holders arranged in a vane configuration according to an embodiment of the subject matter described herein;

FIG. 15 illustrates a plurality of memory card holders that are arranged in a linear array and that are detachably coupled to each other according to an embodiment of the subject matter described herein;

FIG. 16 is a bottom perspective view illustrating an adhesive backing for a memory card holder according to an embodiment of the subject matter described herein;

FIG. 17 is a diagram of a memory card holder attached to a host where the memory card holder is substantially transparent according to an embodiment of the subject matter described herein;

FIG. 18 illustrates a plurality of memory card holders with company logos on an outer-facing surface thereof according to an embodiment of the subject matter described herein; and

FIGS. 19A and 19B are memory card holders with displays on the backing surface that correspond to the memory card that is inserted therein according to an embodiment of the subject matter described herein.

### DETAILED DESCRIPTION

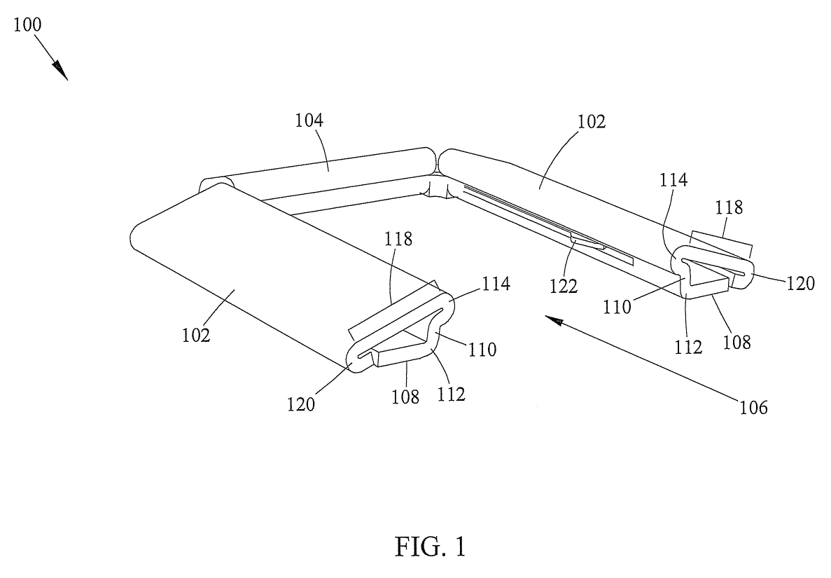

Holders for portable memory cards and methods for manufacturing the same are disclosed. According to one aspect, a low profile holder for a portable memory card can be formed from sheet metal. FIG. 1 is a front perspective view of such a memory card holder according to an embodiment of the subject matter described herein. Referring to FIG. 1, memory card holder 100 includes first and second sidewall members 102 and end wall member 104 that frame a compartment 106 for receiving a portable memory card. Compartment 106 may be an opening, a slot, a niche, a gap, or any other suitable structure for receiving a portable memory card. Each of sidewall members 102 include a base portion 108 for attaching same to a host, such as a media player, a mobile phone, a smart phone, a PDA, a GPS device, a camera, a radio, or combinations thereof. Each of sidewall members 102 also include a sidewall portion 110 that extends outward from base portion 108. In particular, sidewall portions 110 extend outward from ends 112 of base portion 108 that are closest to compartment 106. Each sidewall member 102 also includes an overhanging portion 114 that extends from sidewall portion 110 over compartment 106 at an oblique angle for holding a portable memory card within compartment 106 and, if no backing is included, against a surface of a host, represented by reference numeral 116 in FIG. 1. Each overhanging portion 114 includes a 180° bend and a sloped portion 118 that extends over base portion 108. Each sloped portion 118 also includes a 180° bend 120 that forms a rounded outer edge of each sidewall member 102.

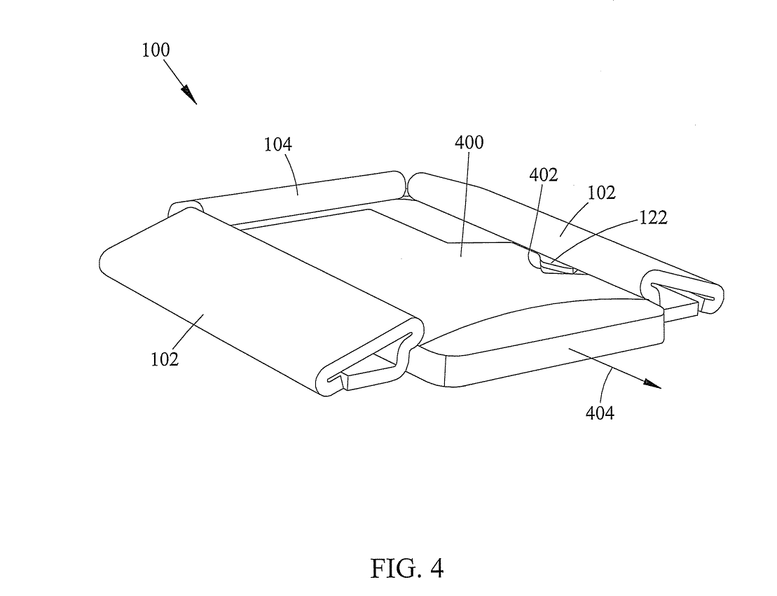

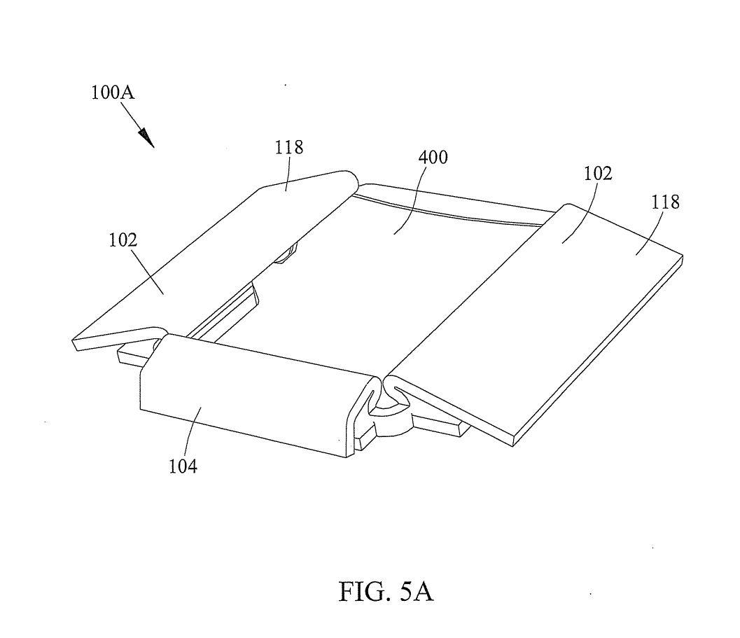

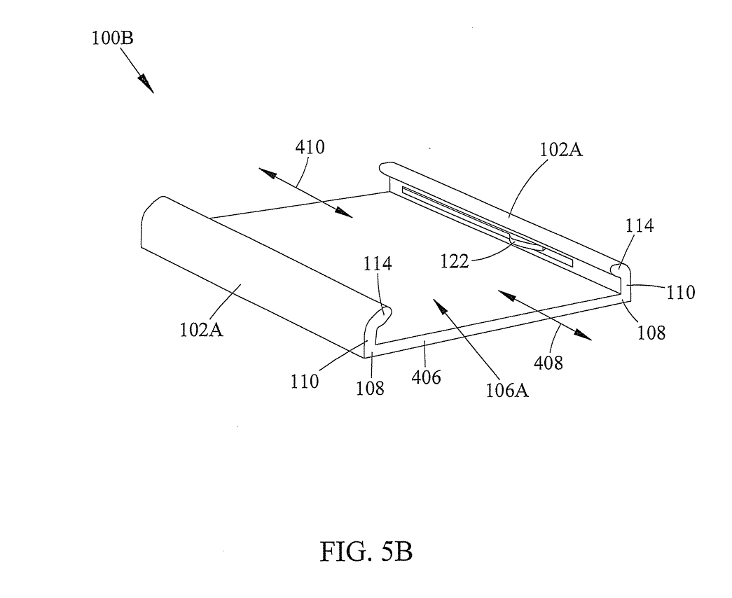

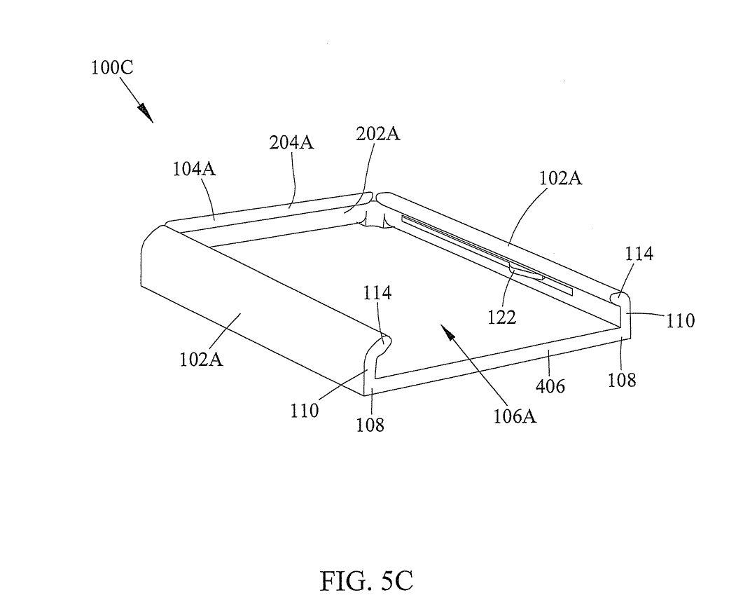

One or both sidewall members 102 may include a spring lock 122 that engages a structure formed in an edge of a portable memory card. Spring lock 122 may include a cantilever beam and a tip that protrudes into compartment 106 and engages the structure on an edge of a portable memory card when the portable memory card is inserted into compartment 106. For example, some portable memory cards, such as micro secure digital (micro-SD) cards, include a slot formed in one of the card's lateral edges. The tip formed on the end of the cantilever beam of spring lock 122 may protrude into the slot when the card is fully inserted into compartment 106 to lock the card within compartment 106, as illustrated in FIGS. 4 and 5. In one example, both sidewall members 102 may include spring locks 122 so that a portable memory card can be inserted in orientations that are flipped 180° from each other and still be locked into compartment 106.

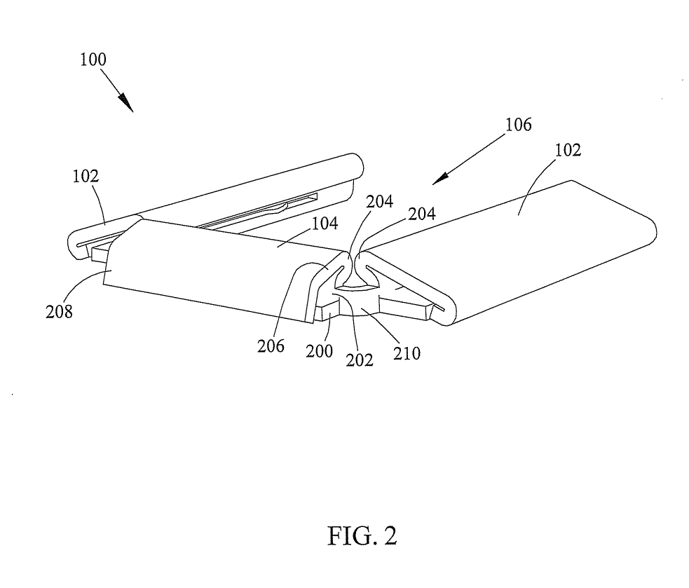

FIG. 2 is a rear perspective view of memory card holder 100 of FIG. 1, illustrating the structure of end wall member 104 in more detail. In the illustrated example, end wall member 104 includes a base portion 200 designed for being attached to a host, a sidewall portion 202 that extends outward from base portion 200, and an overhanging portion 204 that extends from sidewall portion 202 over compartment 106 to retain a portable memory card within compartment 106. Overhanging portion 204 includes a 180° bend. End wall member 104 further includes a sloped portion 206 that extends from the 180° bend over base portion 200 of end wall member 104. End wall member 104 also includes a terminating portion 208 that extends over base portion 200. Joints 210 may be located on opposite ends of end wall member 104 to join end wall member 104 with sidewall members 102.

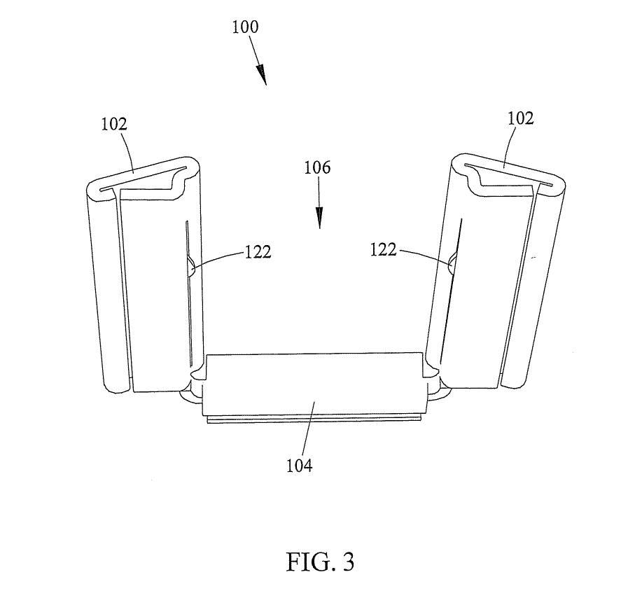

FIG. 3 is a bottom perspective view of memory card holder 100 of FIG. 1. In FIG. 3, the protrusions formed or located on the ends of spring locks 122 are shown on both side wall members 102 to allow locking with flipped orientations of a portable memory card. For example, portable memory cards, such as micro-SD cards, have asymmetric lateral edges. One lateral edge includes a structure that is engaged by the protrusion of spring lock 122. By including spring locks 122 in both sidewall members 102, a portable memory card can be inserted into compartment 106 with either of its major surfaces facing outward. In some examples, the major surface of a portable memory card may include a label that is indicative of the content of a portable memory card. If the user desires for the label to be displayed in holder 100 so that it can be viewed by the user or by others, the user may face the label outward. Alternatively, if privacy of the portable memory card content is desired, the user may desire to face the label inward towards the surface of the host device to which holder 100 attaches. By including spring locks 122 in both sidewall members 102, the user can lock the portable memory card in holder 100 with the option of either displaying or not displaying the label.

FIG. 4 is a front view of memory card holder 100 of FIG. 1 with a memory card 400 inserted therein. In FIG. 4, it can be seen that portable memory card 400 includes a structure on one of its lateral edges that is engaged by spring lock 122. In this configuration, portable memory card 400 can be disengaged from spring lock 122 through application of force in the direction of arrow 404. Such force may be generated by a user pulling memory card 400 with the user's finger in the direction of arrow 404.

In FIG. 4, and in the remaining figures herein, portable memory card 400 is a micro secure digital (micro-SD) card. In the examples described herein, compartment 106 is configured to receive a micro-SD card. However, compartment 106 may be configured to receive other types of removable portable memory cards without departing from the scope of the subject matter described herein.

FIG. 5A is a rear perspective view illustrating a memory card holder 100A that differs from memory card holder 100 illustrated in FIG. 1 in that sloped portions 118 of sidewalls 102 do not include outer 180° bends. The 180° bends in the outer portions of sidewalls 102 illustrated in FIG. 1 reduce the likelihood of the portable memory card catching on an object and being separated from the host. However, the outer bends can be omitted, as illustrated in FIG. 5A, without departing from the scope of the subject matter described herein.

FIG. 5B is a front perspective view of an alternate embodiment of a memory card holder. Referring to FIG. 5B, memory card holder 100B includes sidewall members 102A that extend outward from a backing member 406. Each sidewall member 102A includes a base portion 108 and a sidewall portion 110 that extends outward from opposite ends of backing member 406. Each sidewall member 102A also includes an overhanging portion 114 that extends over compartment 106A. Compartment 106A is framed by sidewall members 102A. Spring lock 122 locks portable memory cards within compartment 106A.

In the embodiment illustrated in FIG. 58. both ends of compartment 106A are substantially open such that a memory card can be inserted or removed from either end of compartment 106A, as illustrated by arrows 408 and 410, because sidewall member 104 illustrated in FIG. 1 is omitted. Spring lock 122 locks the portable memory card within compartment 106A. Backing member 406 increases the structural rigidity of portable memory card holder 100B and provides increased surface area for attaching to a host.

FIG. 5C illustrates yet another embodiment of a memory card holder. Referring to FIG. 5C, memory card holder 100C includes sidewall members 102A and backing member 406 as illustrated in FIG. 5B. However, portable memory card holder 100C includes endwall member 104A. Endwall member 104A includes overhanging portion 204A that extends over compartment 106A at an oblique angle to attain a portable memory card within compartment 106A and a sidewall member 202A that extends outward from backing member 406. Like the embodiment illustrated in FIG. 5B, memory card holder 100C provides increased surface area via backing member 406 for attaching to a host.

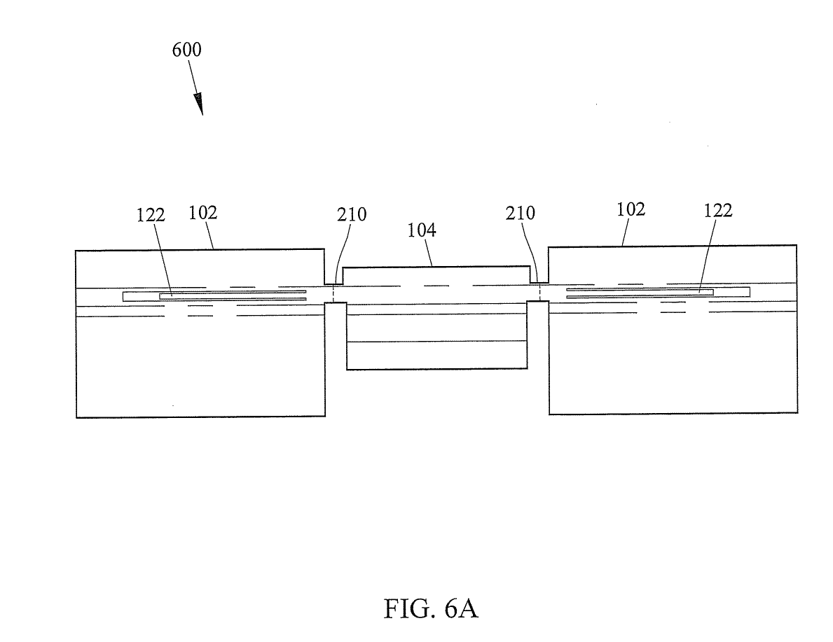

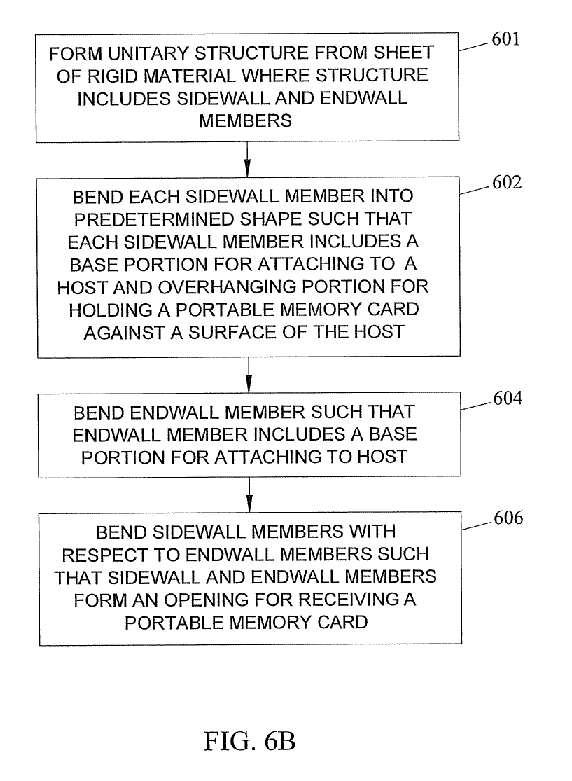

As stated above, in one exemplary implementation, memory card holder 100 illustrated in FIG. 1 can be formed using a single sheet of rigid material, such as sheet metal. FIG. 6A illustrates a unitary structure punched out from a single sheet of metal used to form memory card holder 100. In FIG. 6A, a unitary structure 600 may be formed from a sheet of metal, for example, by punching or cutting unitary structure from the sheet of metal. In the illustrated example, unitary structure 600 includes sidewall members 102, end wall member 104, and joints 210. The dashed lines in FIG. 6A correspond to bending locations used to form the various structures illustrated in FIG. 1. Spring locks 122 are also illustrated in FIG. 6A. Spring locks 122 may be formed by cutting out on three sides a cantilever beam and then bending the end of the cantilever beam to form the protrusion that engages the structure in the edge of a portable memory card.

FIG. 6B is a flow chart illustrating exemplary steps for manufacturing memory card holder 100 illustrated in FIG. 1. Referring to FIG. 6B, in step 601, a unitary structure is formed from a sheet of rigid material where the structure includes sidewall and end wall members. For example, the structure illustrated in FIG. 6A may be punched or cut from a sheet of metal, such as cold rolled steel or aluminum. In step 602, each sidewall member 102 is bent into a predetermined shape such that each sidewall member 102 includes a base portion for attaching to a host and an overhanging portion for holding a portable memory card against the surface of the host. For example, sidewall members 102 illustrated in FIG. 6A may be bent along the dashed lines of FIG. 6A to form the shape of each sidewall member 102 illustrated in FIG. 1.

Returning to FIG. 6B, in step 604, the end wall member 104 is bent such that the end wall member includes a base portion for attaching to a host. The end wall member may also include an overhanging portion. For example, referring to FIG. 6A, end wall member 104 may be bent along the dashed lines to form the shape of end wall member 104 illustrated in FIG. 2.

In step 606, joints 210 are bent such that the sidewall and end wall members frame a compartment for receiving a portable memory card. For example, sidewall members 102 may be bent radially inward about joints 210 (i.e., in a direction out of the page in FIG. 6A) to frame compartment 106 illustrated in FIG. 1.

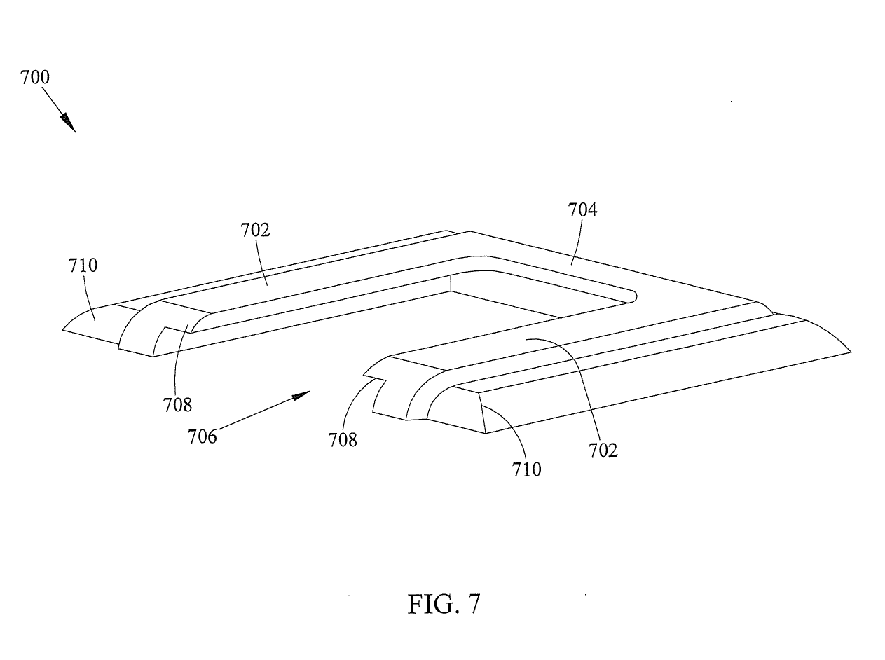

In the examples illustrated in FIGS. 1-6B, a portable memory card is formed by bending a sheet of rigid material. In an alternate implementation, a portable memory card may be formed by a molding process, such as injection molding, and may be made of a plastic material. In yet another example, a memory card holder may be formed by a rapid prototyping process where the structure of the holder is made directly from CAD or other mechanical drawings using sheets or layers of a composite material. FIG. 7 illustrates an example of a memory card holder that can be formed by a molding or rapid prototyping process according to an embodiment of the subject matter described herein. Referring to FIG. 7, memory card holder 700 includes sidewall members 702 and end wall member 704 that frame a compartment 706. Each sidewall member includes an overhanging portion 708 that holds a portable memory card against a surface of a host. In addition, each sidewall member 702 forms a tiered wall with an outer wall portion 710 that is of a lower height than overhanging portion 708. Forming outer wall portion 710 of a lower height than overhanging portion 704 reduces the amount of material required to manufacture memory card holder 700.

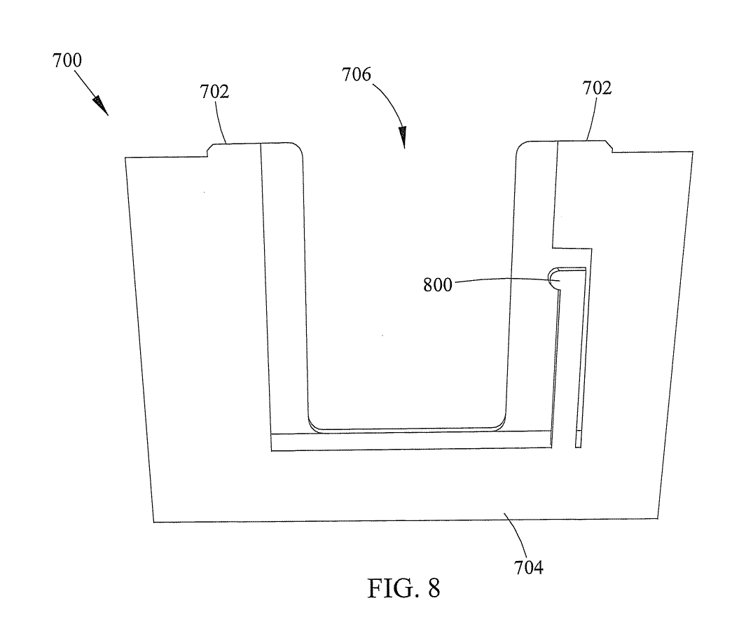

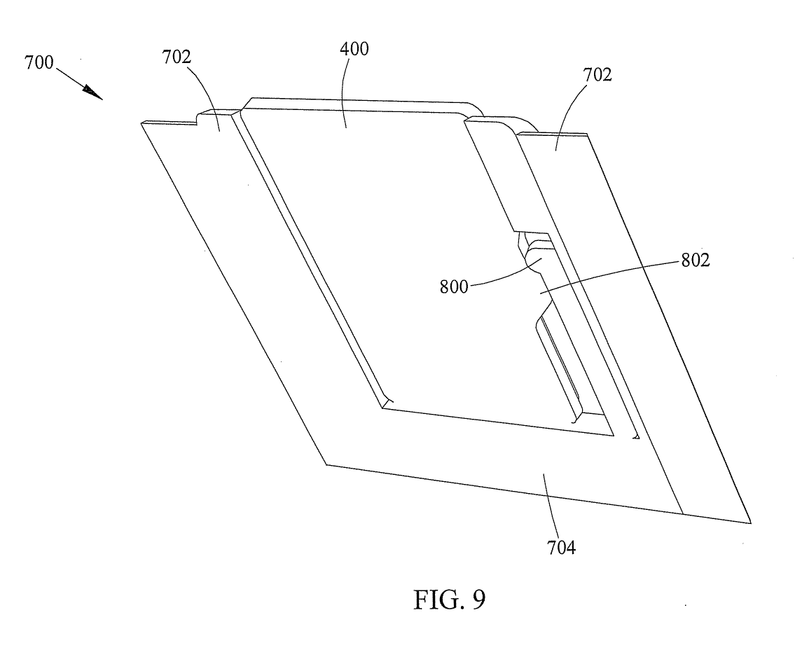

FIG. 8 is a bottom view of memory card holder 700 illustrated in FIG. 7. In FIG. 8, one of the sidewall members 702 includes spring lock 800 that engages the structure on an edge of the portable memory card to lock the portable memory card in compartment 706, as illustrated in FIG. 9. In particular, in FIG. 9, spring lock 800 engages structure 802 that is found on one side of portable memory card 400. In an alternate embodiment of the subject matter described herein, memory card holder 700 may include spring locks 800 in both sidewall members 702 such that portable memory card 400 can be inserted in the orientation illustrated in FIG. 9 or in an orientation that is flipped 180° from the orientation illustrated in FIG. 9.

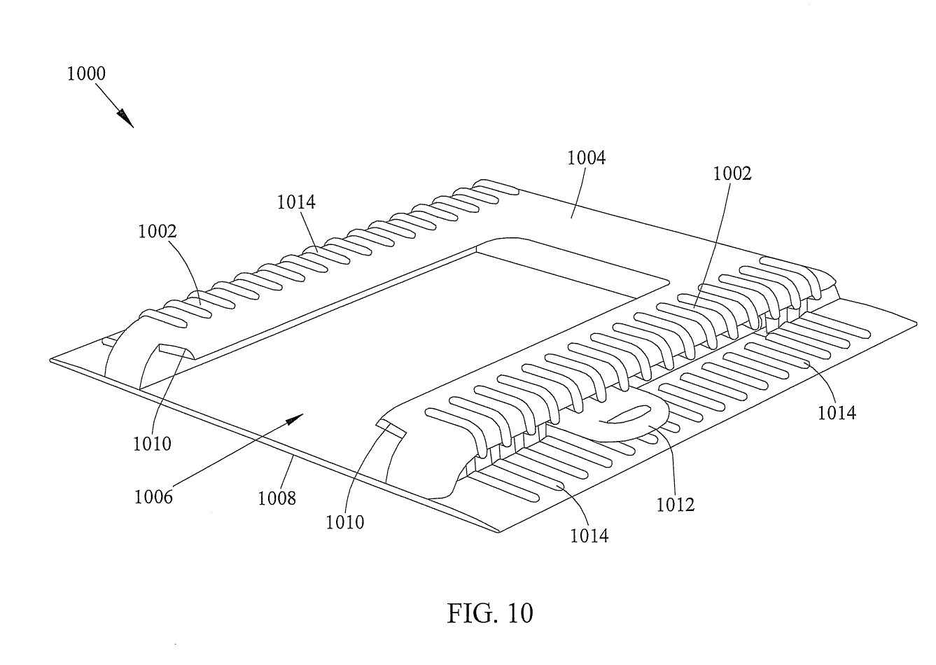

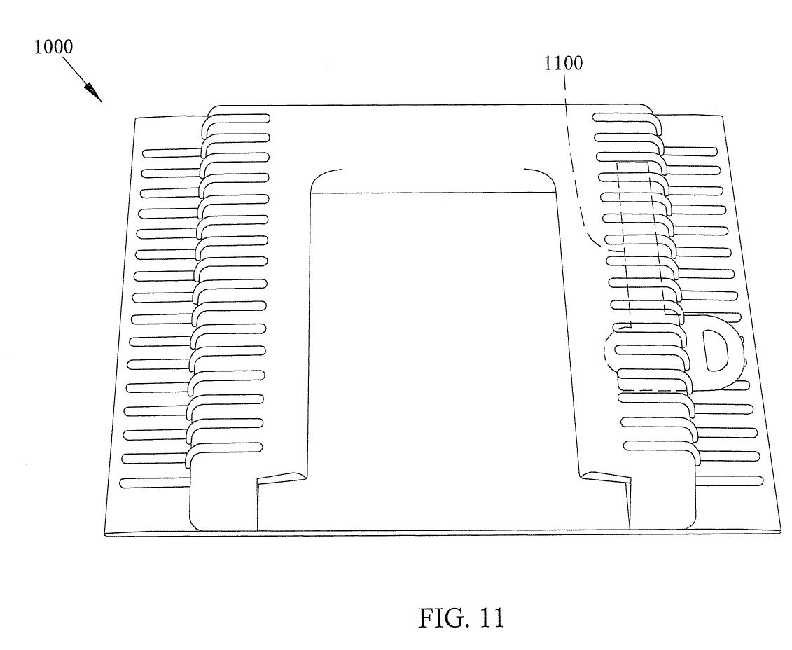

FIG. 10 illustrates yet another example of a memory card holder according to an embodiment of the subject matter described herein. Referring to FIG. 10, memory card holder 1000 includes sidewall members 1002 and end wall member 1004 that form compartment 1006 for receiving a portable memory card. In addition, memory card holder 1000 includes a backing member 1008 that attaches to a host and that provides structural support for sidewall members 1002 and end wall member 1004. Memory card holder 1000 further includes a spring lock 1100 illustrated by dashed lines in FIG. 11 that engages a structure in an edge of a portable memory card in a manner similar to spring lock 122 illustrated in FIG. 1. That is, spring lock 1100 may include a cantilever beam with a protrusion on its tip that engages the structure in the edge of a portable memory card. In FIGS. 10 and 11, an actuator 1012 may be located on the opposite side of the cantilever beam from the protrusion that engages the structure and the edge of a portable memory card and may be accessible from an external surface of memory card holder 1000. Actuator 1012 may be used to disengage spring lock 1100 from the structure in the edge of the portable memory card. Memory card holder 1000 may also include a plurality of parallel ridges 1014. Ridges 1014 may increase the aesthetic appeal of memory card holder 1000 and may also increase the ability of a user to grasp memory card holder 1000.

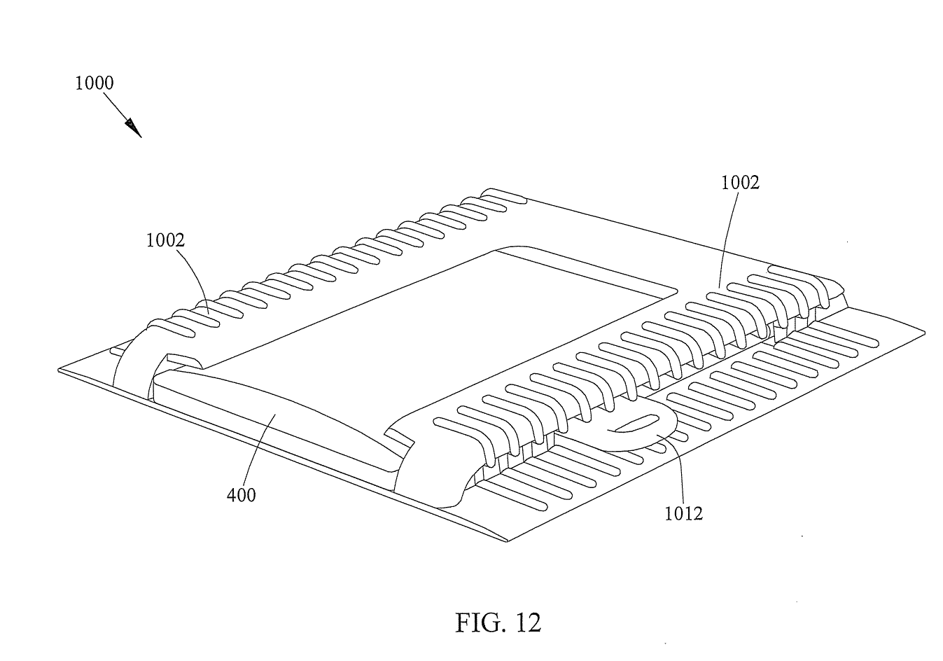

When a memory card is inserted into memory card holder 1000, as illustrated in FIG. 12, a user may disengage spring lock 1100 by pulling actuator 1012 away from sidewall member 1002, in the direction corresponding to arrow 1200. Providing an externally accessible spring lock actuator facilitates removal of memory card 400 from memory card holder 1000.

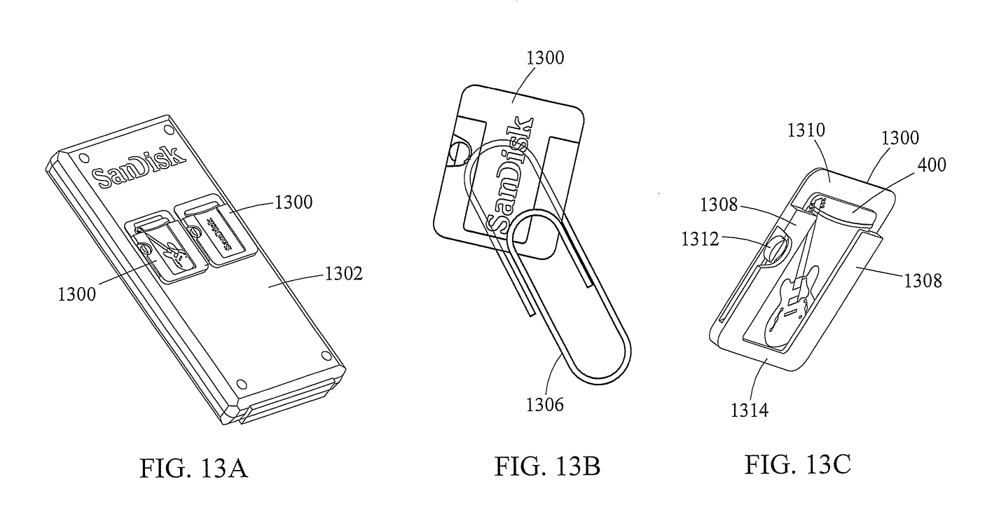

FIGS. 13A-13C illustrate additional examples and uses of a memory card holder according to embodiments of the subject matter described herein. In FIG. 13A, memory card holders 1300 are attached to host 1302. Memory card holders 1300 may have the same configuration as any of the memory card holders described hereinabove or may have a slightly different configuration, as will be described with regard to FIGS. 13B and 13C. Host 1302 may be a portable media player, a mobile phone, or any of the host devices mentioned herein. In FIG. 13B, memory card holder 1300 is shown with a paper clip 1306 to illustrate the small size and low profile of memory card holder 1300. For example, memory card holder 1300 may have a thickness of no more than about 2 millimeters. In addition, memory card holder 1300 may include at least one transparent surface.

In FIG. 13C, memory card holder 1300 is shown with a memory card 400 inserted therein. Memory card holder 1300 includes sidewall members 1308 that hold memory card 400 against a backing member 1310 that attaches to the host device. A spring lock (not shown in FIG. 13C, but similar in structure to spring lock 122) that engages a structure in an edge of portable memory card 400 may be disengaged from the structure in the edge of portable memory card 400 using spring lock actuator 1312. Sidewall members 1308 and an end wall member 1314 may each include an overhanging portion that hold memory card 400 against backing member 1310.

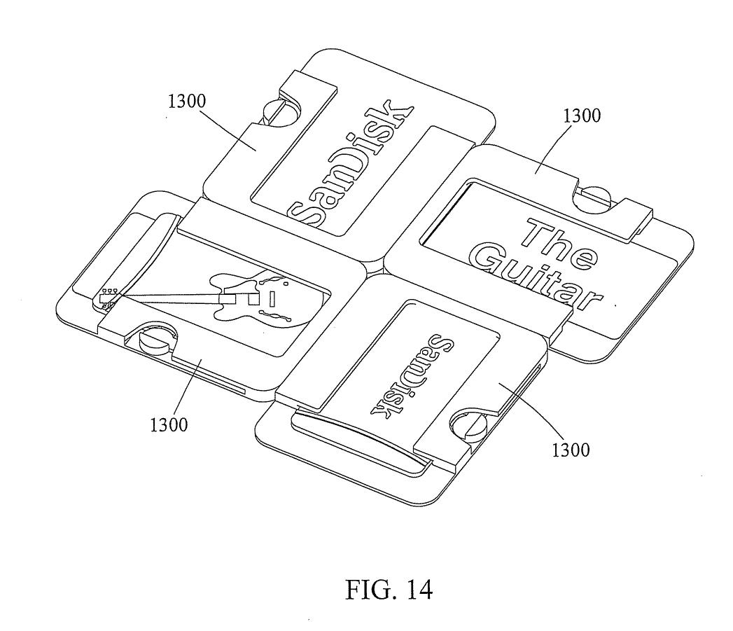

According to another aspect of the subject matter described herein, a plurality of memory card holders 1300 may be located on any surface and arranged in a vane configuration, as illustrated in FIG. 14. In FIG. 14, each memory card holder 1300 is arranged so that its compartment faces outward and does not face another memory card holder. This configuration is referred to herein as a vane configuration. In the example illustrated in FIG. 14, the vane configuration includes four memory card holders 1300 that extend radially outward from a common point or area such that memory cards can be slid radially outward from any of the memory card holders 1300. In an alternate example, the vane configuration may include two memory card holders facing radially outward from a common point or area.

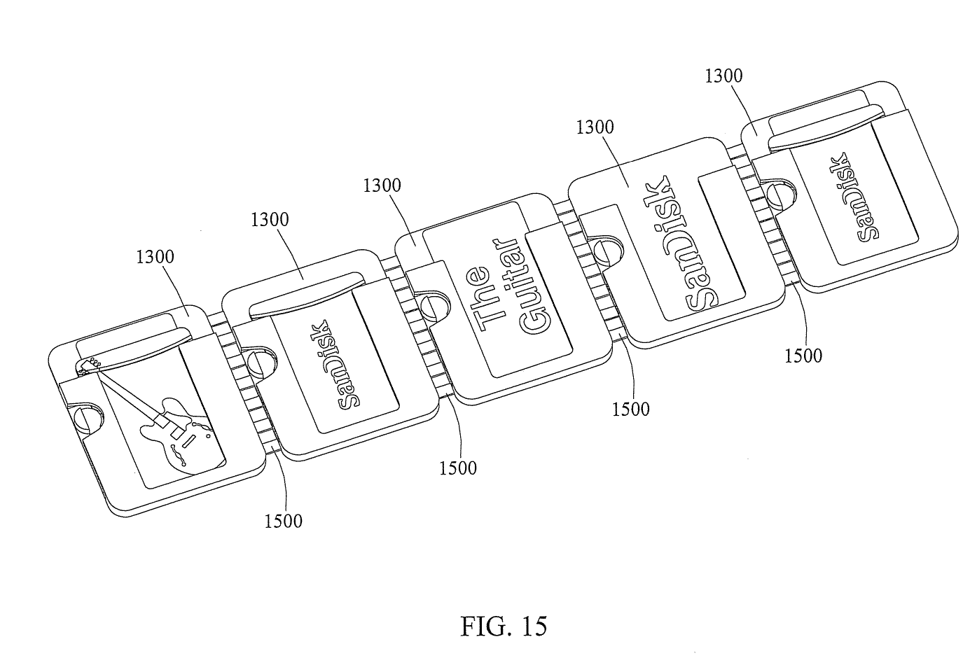

According to another aspect of the subject matter described herein, a plurality of memory card holders can be detachably coupled to each other for storage, removal, and distribution. For example, as illustrated in FIG. 15, memory card holders 1300 are arranged in a linear array and are joined by perforations 1500 formed between adjacent sidewall members 1308 (shown in FIG. 13C). In the configuration illustrated in FIG. 15, the linear array of memory card holders 1300 may be owned by a distributor, such as an artist or a media rights holding company. As individual memory cards are sold or otherwise distributed to end users, the individual memory card holders 1300 may be torn from the linear array along perforations 1500 and distributed to the end users.

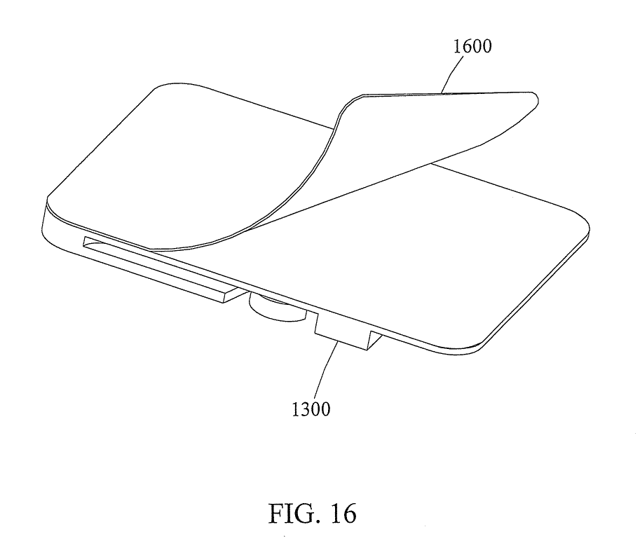

FIG. 16 illustrates an example of an adhesive backing on a memory card holder 1300 that may be used to attach the portable memory card to a host. In the illustrated example, portable memory card holder 1300 includes an adhesive material located on a back surface thereof and covered by a removable cover 1600. When removable cover 1600 is removed, memory card holder 1300 can be attached to a host using the adhesive material that is deposited on its back surface. In an alternate example, the back surface of memory card holder 1300 may include either a sheet of hooks or loops to form a hook and loop fastener connection with the corresponding loop or hook material located on a surface of the host device in which it is desirable to attach the portable memory card. In yet another example, if both memory card holder 1300 and the surface to which the memory card holder 1300 is to be attached are made of thermoplastic materials, memory card holder 1300 can be welded to the surface of the host device, for example, using an ultrasonic welding procedure. In some embodiments, especially those that use hook and loop fasteners to connect to a host, memory card holder 1300 or any of the other memory card holder examples illustrated herein may be detachably couplable to a host device so that the memory card holder can be attached to one host device, detached from that host device, and attached to a second host device.

In FIG. 16, portable memory card holder 1300 has a backing surface between its sidewalls that attaches to a host device. However, as illustrated in some of the examples above, the backing surface between the sidewalls may be omitted without departing from the scope of the subject matter described herein. That is, a portable memory card holder may include a backless design, where the only surfaces that can attach to a host are the base portions of the sidewall and end wall members.

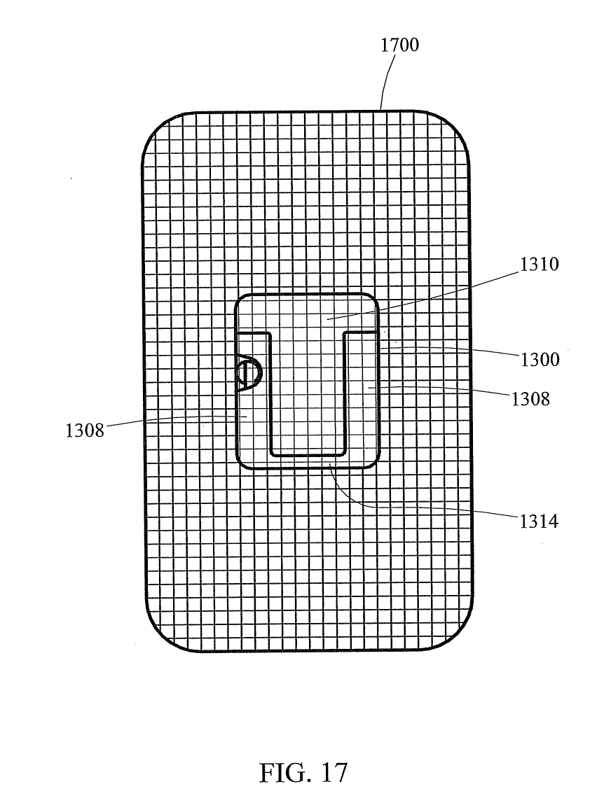

According to yet another aspect of the subject matter described herein, at least one surface of a memory card holder can be substantially clear or optically transparent, as illustrated in FIG. 17. In FIG. 17, each of backing member 1310, sidewall members 1308, and end wall member 1314 are formed of an optically transparent material, such as transparent plastic. As such, when memory card holder 1300 is attached to host device 1700, the surface of host device 1700 to which memory card holder 1300 is attached is not obscured.

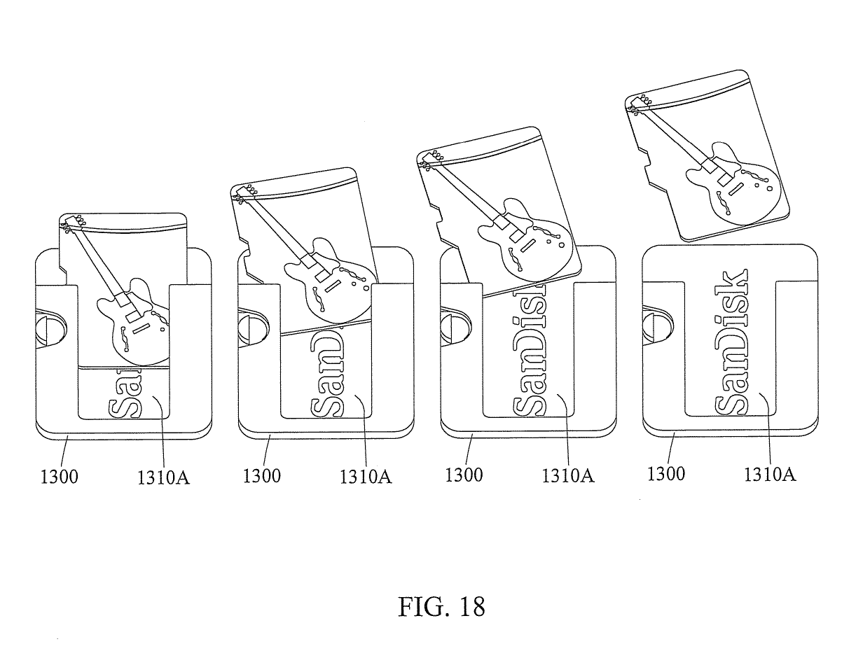

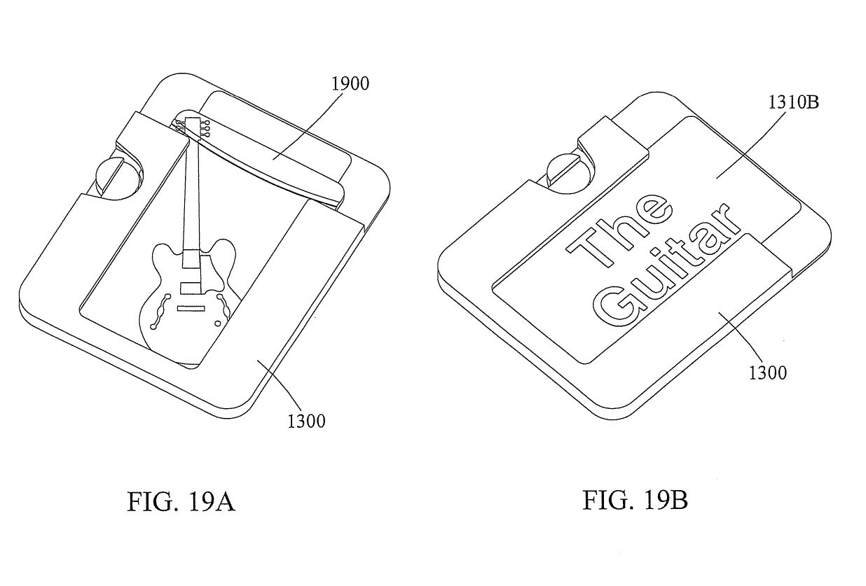

According to yet another aspect of the subject matter described herein, one or more surfaces of a memory card holder may include a display, as illustrated in FIGS. 18, 19A, and 19B. In FIG. 18, an outward facing surface of backing member 1310 is branded with the company logo. In FIG. 19B, the backing surface 1310 of memory card holder 1300 includes a graphical display that indicates the type of memory card that should be inserted. For example, in FIG. 19B, backing surface 1310 indicates “The Guitar” for portable memory card 1900 illustrated in FIG. 19A, which includes an image of a guitar.

As described above, the subject matter described herein includes holders for portable memory cards and methods for manufacturing same. According to one aspect, a holder for a portable memory card is provided. The holder includes first and second sidewall members framing a compartment for receiving a portable memory card. Each of the first and second sidewall members has a base portion designed for being attached to a host device, a sidewall portion extending outward from the base portion, and overhanging portion extending from the sidewall portion over the compartment at an oblique angle for retaining a portable memory card within the compartment.

According to another aspect of the subject matter described herein, another holder for a portable memory card is provided. The holder includes first and second sidewall members framing a compartment for receiving a portable memory card. Each of the first and second sidewall members includes a base portion designed for attaching same to the host and an overhanging portion extending over the compartment for retaining the portable memory card in the compartment and forming a tiered wall having an outer portion of lower height than the overhanging portion.

According to another aspect of the subject matter described herein, yet another holder for a portable memory card is provided. The holder includes first and second sidewall members framing a compartment for receiving a portable memory card. Each of the first and second sidewall members includes a base portion for attaching to the host, an overhanging portion extending over the compartment for retaining the portable memory card within the compartment, and at least one spring lock for engaging a structure in an edge of the portable memory card and locking the portable memory card within the compartment, where the at least one spring lock includes a lock actuator for disengaging the spring lock from the structure in the portable memory card.

According to yet another aspect of the subject matter described herein, a method for manufacturing a holder for a portable memory card is provided. The method includes forming a unitary structure from a sheet of rigid material, the unitary structure including first and second sidewall members, an end wall member, and joints between the sidewall members and the end wall member. The method further includes bending the sidewall members to form a base portion for attaching same to a host and an overhanging *lion for holding a portable memory card against a surface of the host. The method further includes bending the end wall member to include a base portion that attaches to the host. The method further includes bending the joints such that the sidewall members and the end wall member frame a compartment for receiving the portable memory card.

In the examples described above, different combinations and features are illustrated as being associated with different embodiments. However, any of the features of any embodiment can be combined with or omitted from the features of any other embodiment without departing from the scope of the subject matter described herein.

It will be understood that various details of the presently disclosed subject matter may be changed without departing from the scope of the presently disclosed subject matter. Furthermore, the foregoing description is for the purpose of illustration only, and not for the purpose of limitation.

1. A holder for a portable memory card, the holder comprising:
first and second sidewall members framing a compartment; and
each of the first and second sidewall members having a base portion designed for being attached to a host, a sidewall portion extending outward from the base portion, and an overhanging portion extending from the sidewall portion inward over the compartment at an oblique angle and for retaining the portable memory card within the compartment, wherein the compartment is configured to receive and store a portable memory card separately from a portable memory card being accessed by the host.

2. The holder of claim 1 wherein the first and second sidewall members are formed from a single sheet of rigid material.

3. The holder of claim 2 wherein the rigid material comprises sheet metal.

4. The holder of claim 1 wherein the overhanging portion includes a 180° bend and wherein each of the sidewall members further includes a sloped portion extending from the 180° bend in the overhanging portion and over the base portion.

5. The holder of claim 4 wherein the sloped portion of each sidewall member includes a 180° bend to form a rounded outer edge of each sidewall member.

6. The holder of claim 1 wherein at least one of the sidewall members includes a spring lock for engaging a structure in an edge of the portable memory card to lock the portable memory card in the compartment.

7. The holder of claim 1 comprising an end wall member that terminates one end of the compartment, wherein the end wall member includes a base portion, a sidewall portion extending outward from the base portion of the end wall member, and an overhanging portion extending over the compartment from the sidewall portion of the end wall member at an oblique angle for retaining the portable memory card within the compartment.

8. The holder of claim 1 comprising a backing portion located between the base portions of the sidewall members for attaching to the host and wherein the compartment is open on both ends of the backing portion to allow insertion and removal of the portable memory card from either end of the backing portion.

9. The holder of claim 7 wherein the overhanging portion of the end wall member includes a 180° bend and wherein the end wall member further includes a sloped portion extending from the bend in the overhanging portion and over the base portion of the end wall member.

10. The holder of claim 1 wherein the compartment is configured to receive a micro secure digital (micro-SD) card.

11. The holder of claim 1 wherein the base portions of the sidewall members are detachably couplable to the host.

12. A method for manufacturing a holder for a portable memory card, the method comprising:
forming a unitary structure from a sheet of rigid material, wherein the unitary structure includes first and second sidewall members, an end wall member, and joints between the sidewall members and the end wall member;
bending each of the sidewall members into a predetermined shape such that each of the sidewall members includes a base portion for attaching to a host and an overhanging portion for holding a portable memory card against a surface of the host;
bending the end wall member such that the end wall member includes a base portion for attaching to the host; and
bending the joints such that the sidewall members and the end wall member frame a compartment for holding the portable memory card within the compartment, wherein the compartment is configured to receive and store a portable memory card separately from a portable memory card being accessed by the host.

13. A holder for a portable memory card, the holder comprising:
first and second sidewall members framing a compartment; and
each of the first and second sidewall members including a base portion for attaching to a host and an overhanging portion extending over the compartment for retaining the portable memory card within the compartment, and forming a tiered wall having an outer portion of lower height than the overhanging portion, wherein the compartment is configured to receive and store a portable memory card separately from a portable memory card being accessed by the host.

14. The holder of claim 13 wherein at least one of the first and second sidewall members includes a spring lock for engaging the structure in an edge of the portable memory card and locking the portable memory card in the compartment.

15. The holder of claim 14 wherein both of the first and second sidewall members include the spring locks for locking the portable memory card in the compartment in orientations that are flipped 180° from each other.

16. The holder of claim 13 wherein the area between the first and second sidewall members is substantially open.

17. The holder of claim 13 wherein the compartment is configured to receive a micro secure digital (micro-SD) card.

18. The holder of claim 13 wherein the base portions of the sidewall members are detachably couplable to the host.

19. A holder for a portable memory card, the holder comprising:
first and second sidewall members framing a compartment;
each of the first and second sidewall members including a base portion for attaching to a host and an overhanging portion extending over the compartment for retaining the portable memory card in the compartment; and
wherein at least one of the first and second sidewall members includes a spring lock for engaging a structure in an edge of the portable memory card and a lock actuator accessible from an external surface of the at least one sidewall member for moving the spring lock to disengage the spring lock from the structure in the edge of the portable memory card, wherein the compartment is configured to receive and store a portable memory card separately from a portable memory card being accessed by the host.

20. The holder of claim 19 wherein the sidewall members and the end wall member include a plurality of parallel ridges that are spaced from each other.

21. The holder of claim 19 comprising a backing portion located between the first and second sidewall members.

22. The holder of claim 21 wherein the backing portion includes one of:
an adhesive material, a hook material, and a loop material for attaching the holder to the host.

23. The holder of claim 21 wherein at least one of the backing portion and the sidewall members is substantially transparent.

24. The holder of claim 21 comprising an image located on an outward facing surface of the backing portion.

25. The holder of claim 21 wherein the backing portion and the base portions of the sidewalls are detachably couplable to the host.

26. A plurality of holders as claimed in claim 19 that are detachably coupled to each other and that form a linear array.

27. A plurality of holders as claimed in claim 19 wherein the holders face radially outward from a common area forming a vane configuration.

28. The holder of claim 19 wherein the compartment is configured to receive a micro secure digital (micro-SD) card.
